(19) United States
(12) Patent Application Publication
(10) Pub. No.: US 2014/0068454 A1
(43) Pub. Date: Mar. 6, 2014

(54) PRINTING SYSTEM INCLUDING A SERVER THAT GENERATES USER INTERFACES FOR A CONTROL PANEL OF THE PRINTING SYSTEM

(71) Applicants: Toshiba Tec Kabushiki Kaisha, Tokyo (JP); Kabushiki Kaisha Toshiba, Tokyo (JP)

(72) Inventors: Mika HIRAMA, Tokyo (JP); Tomonori IKUMI, Shizuoka (JP); Masami TAKAHATA, Tokyo (JP); Naoki WATANABE, Tokyo (JP); Akihiko FUJIWARA, Kanagawa (JP)

(21) Appl. No.: 13/928,003

(22) Filed: Jun. 26, 2013

(30) Foreign Application Priority Data
Aug. 31, 2012 (JP) 2012-191187

(51) Int. Cl. G06F 3/0484

(52) U.S. Cl. CPC G06F 3/0484
USPC 715/744

(57) ABSTRACT

A user interface including one or more components is created to be displayed on an operation display of a device. The method for creating the user interface includes acquiring layout information indicating a layout of the user interface in which one or more components are arranged, controlling a setting display to display information indicating the layout and a setting panel on which each of the components can be selected from a list of one or more components available for the layout and a function to be associated with each of the selected components can be selected, recognizing the component and the function that are selected on the setting panel, acquiring component information associated with the recognized component, and creating the user interface based on the acquired layout information, the recognized function, and the acquired component information.

### CROSS-REFERENCE TO RELATED APPLICATION

This application is based upon and claims the benefit of priority from Japanese Patent Application No. 2012-191187, filed Aug. 31, 2012, the entire contents of which are incorporated herein by reference.

### FIELD

The embodiments described herein relate to a technique for creating a user interface displayed on a display of a device by which a user operates the device.

### BACKGROUND

There has been proposed a print on-demand system in which a user can print a document stored in a server using a multi-function peripheral (MFP) set in a shop or a public institution such as a school and the like.

In the print on-demand system, the server controls a display unit of the MFP to display an input screen (e.g., a user interface) for acquiring information corresponding to an operation desired by a user. The user interface displays, for example, a button that the user would operate to search for a document which the user wants to print and an icon indicating the document. Through the input on the user interface, a user can search for his or her desired document and print it out using the MFP.

However, the structure of the user interface is different depending on a system provider, because needs of the users of the different systems vary. Therefore, a user interface needs to be customized for every system provider, and during this process, the structure of components (for example, color, shape, and arrangement position of a button and icons) has to be reconsidered.

### DESCRIPTION OF THE DRAWINGS

FIG. 1 is a block diagram illustrating an example of a print on-demand system including a server according to an embodiment.

FIG. 2 is a functional block diagram of the server according to the embodiment.

FIG. 3 is a view illustrating an example of an operation panel displaying a user interface created by the server according to the embodiment.

FIG. 4 is a view illustrating an example of a screen from which a setting screen to create the user interface can be accessed.

FIG. 5 shows an example of the setting screen through which the component specification information and the operation information are obtained.

FIG. 6 shows another example of the setting screen through which the component specification information and the operation information are obtained.

FIG. 7 is a view illustrating an example of a user interface created by the server according to the embodiment.

FIG. 8 is a view illustrating an example of another user interface that is accessed from the user interface created by the server according to the embodiment.

FIG. 9 is a view illustrating an example of another user interface that is accessed from the user interface created by the server according to the embodiment.

FIG. 10 is a view illustrating an example of an image that is accessed from the user interface created by the server according to the embodiment.

FIG. 11 is a flow diagram showing the steps of printing performed in a print on-demand system that includes the server according to the embodiment.

FIG. 12 is a flow diagram showing the steps of creating a user interface according to an embodiment.

FIG. 13 illustrates another example of a component.

FIG. 14 illustrates another example of the setting screen.

### DETAILED DESCRIPTION

Embodiments provide a technique capable of customizing a user interface for each system provider more easily.

Generally, the method according to the embodiment is for creating a user interface including one or more components that is to be displayed on an operation display of a device. The method includes acquiring layout information indicating a layout of the user interface in which one or more components are arranged, controlling a setting display to display information indicating the layout and a setting panel on which each of the components can be selected from a list of one or more components available for the layout and a function to be associated with each of the selected components can be selected, recognizing the component and the function that are selected on the setting panel, acquiring component information associated with the recognized component, and creating the user interface based on the acquired layout information, the recognized function, and the acquired component information.

Hereinafter, embodiments will be described with reference to the drawings.

In the following description, an example of the system including the server according to the embodiment will be explained by using a print on-demand system.

In this specification, a user means a person who is provided with a service such as printing of a document by using the system. Specifically, the user includes a customer visiting a shop and a user in public institutions such as a school and a civic office. A system provider means a party who provides a user with the service through the system and specifically, includes shops and public institutions such as a school and a civic office. Even if a person is employed in the party of the system service provider, he or she may receive the system service and in this case, the person corresponds to the user. For example, if an employee of a shop prints a document such as a shift table and a time-off request through the print on-demand system, the employee corresponds to the user in this specification.

Further, a screen producer means a party who produces a screen to be displayed on a display unit (for example, a display on MFP) included in a terminal where a user enters an operation request at a time of using a system, according to a request of the system provider.

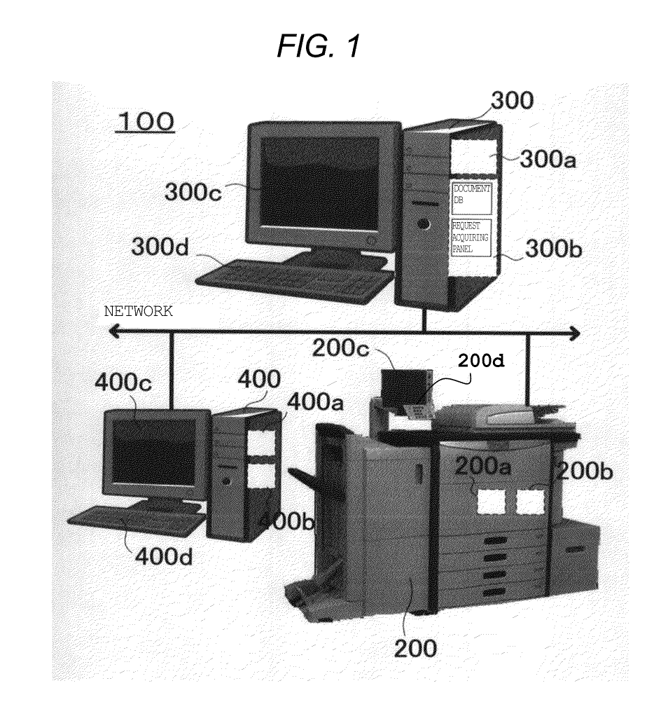

FIG. 1 is a block diagram illustrating an example of a print on-demand system including a server according to the embodiment. The print on-demand system (hereinafter, simply referred to as a print system) 100 includes an MFP (Multi Function Peripheral) 200 and a server 300.

As illustrated in FIG. 1, the print system 100 includes the MFP (Multi Function Peripheral) 200, the server 300, and a client PC 400. Further, each component is mutually connected through a network such as LAN, WAN, and wireless LAN.

Each component of the server 300 and the client PC 400 has the standard elements installed in a general purpose computer. For example, as the standard elements, there are a CPU (300a, 400a), a storage area (300b, 400b) such as RAM, ROM, hard disk, and an external memory, a network interface, a display (300c, 400c), and an operation unit (300d, 400d) such as a keyboard and a mouse. Similarly, the MFP 200 includes the standard elements such as a CPU 200a, a storage area 200b such as RAM, ROM, and a hard disk, a scanner, a printer, a display unit (display) 200c, an operation unit 200d such as a touch panel display and buttons, and an interface for communicating with the outside.

The server 300 controls the MFP 200 to execute a predetermined operation by the internal CPU 300a executing an application program stored in the storage area 300b such as ROM.

For example, the server 300 controls the MFP 200 to display on the display unit 200c a screen (a user interface) for a user's entering his or her request, which is stored in the storage area 300b. A user searches for a document stored in a document database (document DB) within the storage area 300b of the server 300 or requests the printing of a document, through the request acquiring panel displayed on the display unit 200c of the MFP 200. Further, when receiving a printing request from a user through the user interface, the server 300 transfers the data of the selected document stored in the document DB to the MFP 200, and controls the MFP 200 to print the document.

In the following description, for the sake of easy understanding, in order to distinguish the user interface from a setting screen, the user interface and a template screen which can become the user interface as the result of edits may be referred to as a panel.

The client PC 400 creates a document by the internal CPU 400a executing an application program stored in the storage area 400b such as ROM. The created document can be printed by the MFP 200 according to a user's request acquired through the MFP 200 and is stored, for example, in the document DB within the storage area 300b of the server 300. Within the document DB, a document can be stored associated with attributes (for example, created date and category of the document).

The MFP 200 has a monochrome or color copy function, a monochrome or color scanner function, and a monochrome or color printer function. Further, the MFP 200 is configured to perform the functions of a network printer and facsimile, to transmit a scanned image to a desired destination using E-mail by the MFP 200 being connected to a network, and to store the scanned image in an exchangeable way on a network.

Further, the MFP 200 displays the user interface on the display unit 200c according to a control of the server 300 and acquires a request corresponding to a user's operation through the user interface. The MFP 200 transfers the acquired request to the server 300. Further, according to a control of the server 300 in reply to the transferred request, the MFP 200 displays a new user interface which is determined to be displayed next on the display unit or performs a predetermined printing.

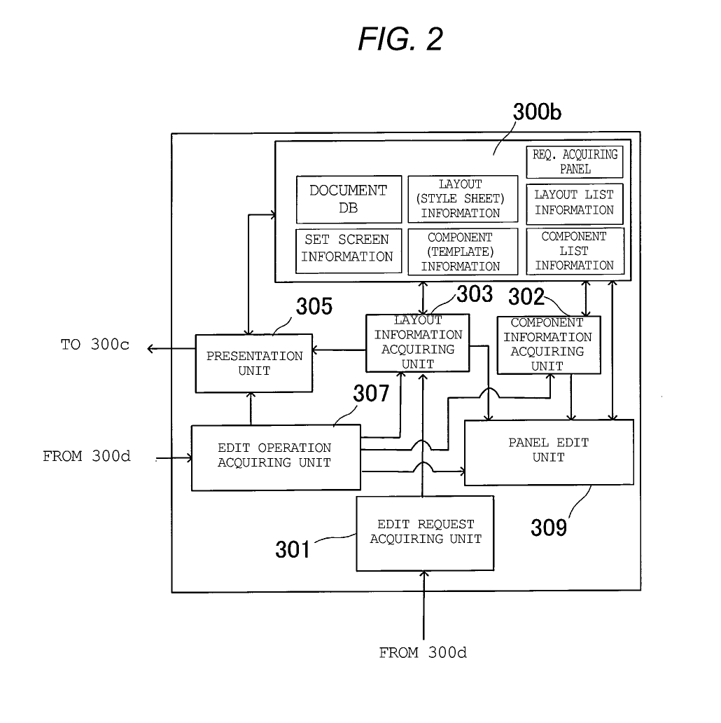

Next, the creation of a user interface in the server 300 according to the embodiment will be described. FIG. 2 is a functional block diagram for the creation of a user interface in the server 300 according to the embodiment.

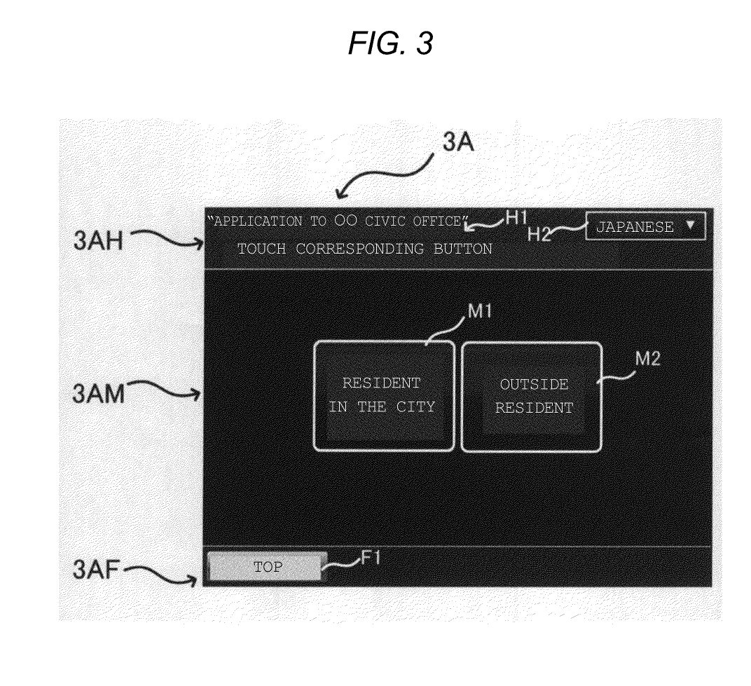

The server 300 according to the embodiment can create a user interface 3A as illustrated in FIG. 3, based on a screen producer's input. The user interface 3A illustrated in FIG. 3 is formed by a combination of header 3AH, footer 3AF, and main region 3AM.

For example, in the header 3AH, a title and a logo such as a company name, or UI for switching language can be inserted as the component. In the footer 3AF, for example, the UI with a function of returning to the initial screen, moving to the next screen, or printing can be arranged. In the main region 3AM, for example, a button, a thumbnail, a check box, a calendar view and a list view showing file names and icons, and a radio button can be arranged. By arranging the components in these three regions, a user interface of uniform design can be created easily.

In the user interface 3A illustrated in FIG. 3, a title and an instruction for operation H1, and a language switcher list H2 are set in the header 3AH. A button F1 for moving to another panel is set in the footer F1. Buttons M1 and M2 for moving to another panel are also set in the main region 3AM.

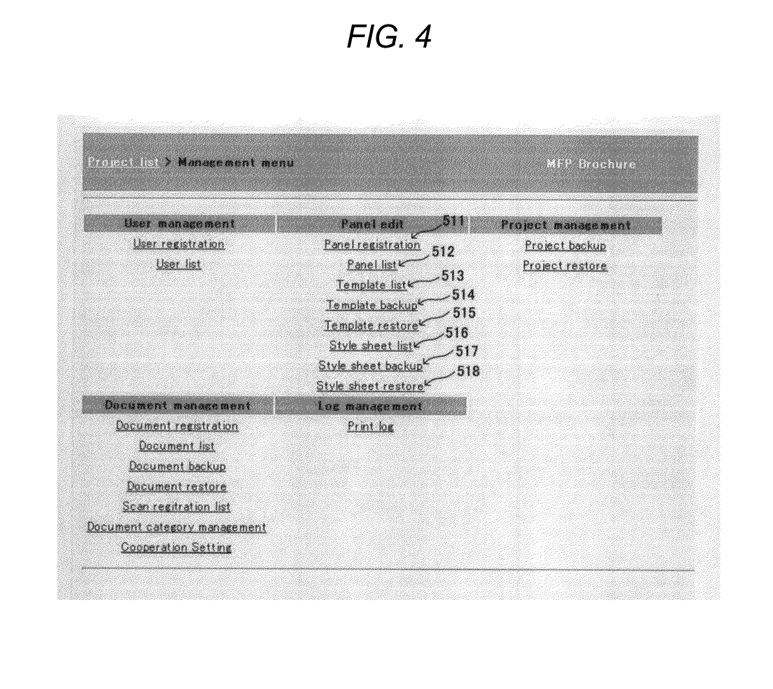

The server 300 displays, for example, a screen as illustrated in FIG. 4 on the display unit 300c, and acquires a request for creating a user interface from a screen producer through the screen. In the screen illustrated in FIG. 4, by clicking a link 511, the screen can be moved to a screen for storing a new panel which is to be set as the user interface in the storage area 300b, and by clicking a link 512, a list of the panels which have been already registered and editable can be displayed. In the embodiment, in order to create a user interface, a new panel is first created and stored in the storage area 300b. Then, the panel stored in the storage area 300b is edited, hence to create a new user interface.

As illustrated in the screen of FIG. 4 by way of example, links to the screens showing lists of the components and the screen layout stored in the storage area 300b, and their edit, backup, and recovery (restore) are displayed as the links 513 to 518 on the screen.

The server 300 according to the embodiment includes the storage area 300b, an edit request acquiring unit 301, a layout information acquiring unit 303, a presentation unit 305, an edit operation acquiring unit 307, a panel edit unit 309, and a component information acquiring unit 302.

When the link 512 is clicked on the screen illustrated in FIG. 4, a list of the editable panels which are stored in the storage area 300b is displayed on the display unit 300c of the server 300. A screen producer can select one of the listed panels and execute the selection using the operation unit 300d. According to this, the screen producer can enter a request for creating a user interface with the selected panel, into the server 300, together with the information for identifying the selected panel (for example, panel name).

The edit request acquiring unit 301 acquires the request for creating a user interface and the information for identifying the selected panel entered into the server 300 by the screen producer through the operation unit 300d. The edit request acquiring unit 301 informs the layout information acquiring unit 303 that it has received the request for creating a user interface from the screen producer and at the same time, transfers the information for identifying the selected panel to the layout information acquiring unit 303.

In addition to the above-mentioned document DB and created user interface, the layout information, set screen information, component information, component list information, and layout list information are stored in the storage area 300b.

The layout information is information which can be used for creating a user interface and associating each component with each function, including the information indicating a predetermined layout of the components within a panel. Further, the layout information may include information related to the layout indicated by the above information (referred to as layout-related information; for example, information indicating the created date of the layout and the components used in the layout and information indicating the panel using the relevant layout). The layout-related information having various contents may be stored in the storage area 300b as the layout information.

The layout list information is information in which part or all of the available layouts which are stored in the storage area 300b are listed.

The component information is information indicating the contents of each component that can be arranged within a panel. Specifically, the component information may include a button, a thumbnail, a check box, a calendar view and a list view showing file names and icons, and a radio button.

The component list information is information in which part or all of the available components which are stored in the storage area 300b are listed.

The setting screen information is information used by the presentation unit 305 for presenting a list of layouts and components and a function of each component set within the panel.

The layout information acquiring unit 303 acquires the layout information stored in the storage area 300b, in response to the notice from the edit request acquiring unit 301. Here, using the information for identifying the selected panel transferred from the edit request acquiring unit 301, if the layout information used for the selected panel exists in the storage area 300b, the layout information acquiring unit 303 acquires the relevant layout information. On the other hand, if the layout information already used is not in the storage area 300b, the unit 301 acquires the layout information corresponding to a default layout (a layout to be presented to the screen producer by default) from the storage area 300b. The layout information acquiring unit 303 transfers the acquired layout information to the presentation unit 305 and the panel edit unit 309.

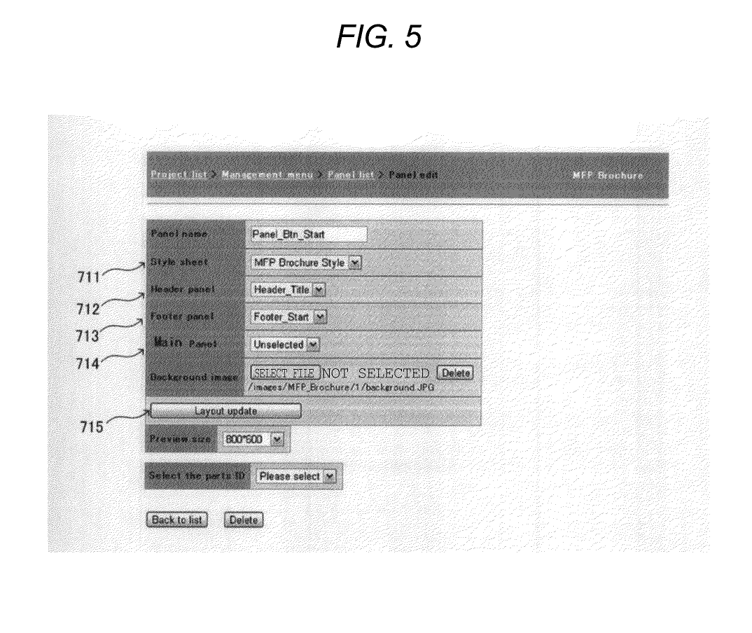

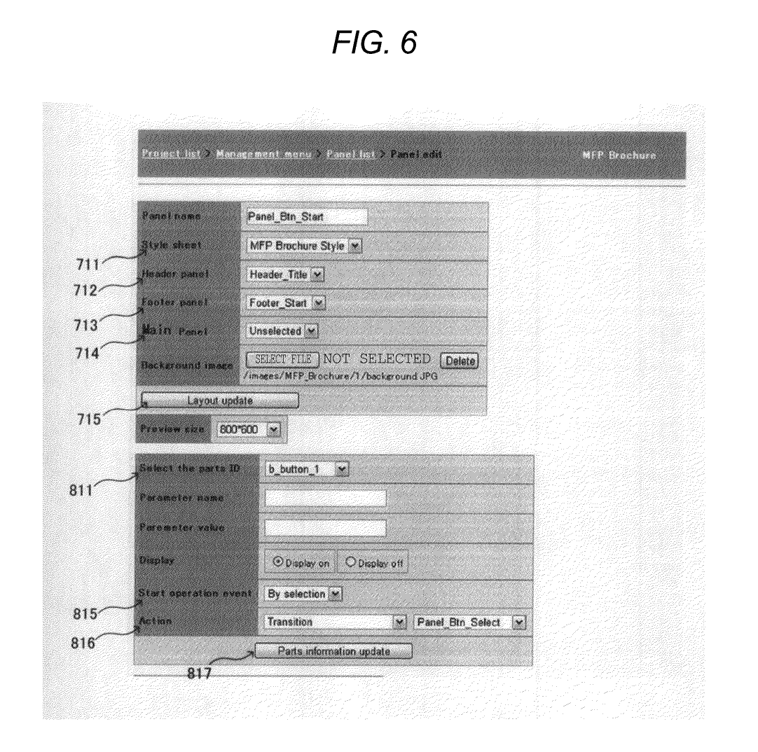

The presentation unit 305 presents the screen layout and the available components to the screen producer. Specifically, upon receipt of the layout information from the layout information acquiring unit 303, the presentation unit 305 creates a setting screen, for example, as illustrated in FIGS. 5 and 6, by using the layout information, the component list information stored in the storage area 300b, and the setting screen information, and displays the setting screen together with a screen indicating the layout on the display unit 300c. Namely, in the embodiment, the presentation unit 305 corresponds to a component presentation unit.

On the setting screens illustrated in FIGS. 5 and 6, reference numerals 712, 713, and 714 are each a list box for selecting a component with the buttons shown respectively in the header, the footer, and the main region. A reference numeral 715 is a button for entering the definition of the function for each component of the panel (correlation of component and function) into the server 300. The reference numeral 711 is a list box for selecting a layout to use (the details will be described below).

On the setting screen shown in FIG. 5, when the component arrangement position within a layout is selected in the list boxes 712, 713, and 714, a box or a window for specifying the component and defining the function for the specified component, as illustrated in FIG. 6, is displayed.

Here, a reference numeral 811 is a list box for selecting a component. A reference numeral 815 is a list box for selecting a user's operation on the component to trigger the function. A reference numeral 816 is a list box for selecting the function to be executed through the manipulation of the component. Further, a reference numeral 817 is a button for temporarily storing the operation defined for the above component into the storage area 300b.

The component specifying information for specifying each component to be arranged within the panel and the function information as for the functions to be executed based on the user's input on each of the components, each of which is associated with each component shown in the component specifying information, are entered into the server 300, according to a user's input on the above setting screen.

The edit operation acquiring unit 307 acquires the component specifying information and the function information entered through the 300d (for example, by touching the button 715 illustrated in FIG. 5). Namely, the edit operation acquiring unit 307 corresponds to a part operation acquiring unit. The edit operation acquiring unit 307 transfers the acquired function information to the panel edit unit 309. The edit operation acquiring unit 307 transfers the component specifying information to the component information acquiring unit 302.

The component information acquiring unit 302 acquires the component information corresponding to the components shown by the component specifying information, which is stored in the storage area 300b, according to the component specifying information transferred from the edit operation acquiring unit 307. The component information acquiring unit 302 transfers the acquired component information to the panel edit unit 309.

The panel edit unit 309 creates a user interface by using the layout information acquired by the layout information acquiring unit 303, the function information acquired by the edit operation acquiring unit 307 (part operation acquiring unit), and the component information acquired by the component information acquiring unit 302. The panel edit unit 309 stores the created request acquiring panel into the storage area 300b.

The list box 711 may be operated on the setting screen illustrated in FIG. 5. According to this, a request for presenting the layout list information is entered into the server 300. Upon receipt of the request, the edit operation acquiring unit 307 informs the presentation unit 305 that there is the request for presenting the layout list information. The presentation unit 305 acquires the layout list information stored in the storage area 300b and controls the display unit 300c to display the list of layouts (specifically, in the list box 711 on the screen illustrated in FIG. 5). Namely, the presentation unit 305 also corresponds to a layout list presentation unit.

The edit operation acquiring unit 307 acquires the layout identifying information for identifying a layout, through the screen producer's input in the list box 711 based on the presentation of the layout list information by the presentation unit 305. The edit operation acquiring unit 307 informs the layout information acquiring unit 303 of the acquired layout identifying information. The layout information acquiring unit 303 acquires the layout information as for the identified layout from the storage area 300b, according to the acquired layout identifying information and transfers the layout information to the presentation unit 305 and the panel edit unit 309. According to this, a user interface is created based on a newly selected layout.

Further, in the creation of a user interface, when one or plural associated images (also referred to as an associated panel) associated with function of a component shown in the function information are, for example, stored in the storage area 300b, if a user operates the component which is associated with the function shown in the function information on the user interface, the panel edit unit 309 can create another user interface so that the associated image should be displayed on the display unit 200c of the MFP 200.

For example, when receiving the function information, the panel edit unit 309 determines whether the associated panel which is associated with the function shown in the function information is stored in the storage area 300b. The associated panel includes, for example, the information related to the correlation with a specific function, within the association information. If the associated panel of the function shown in the function information is determined to be stored in the storage area 300b, the panel edit unit 309 creates a user interface so that the associated panel should be displayed when a user operates the component corresponding to the function.

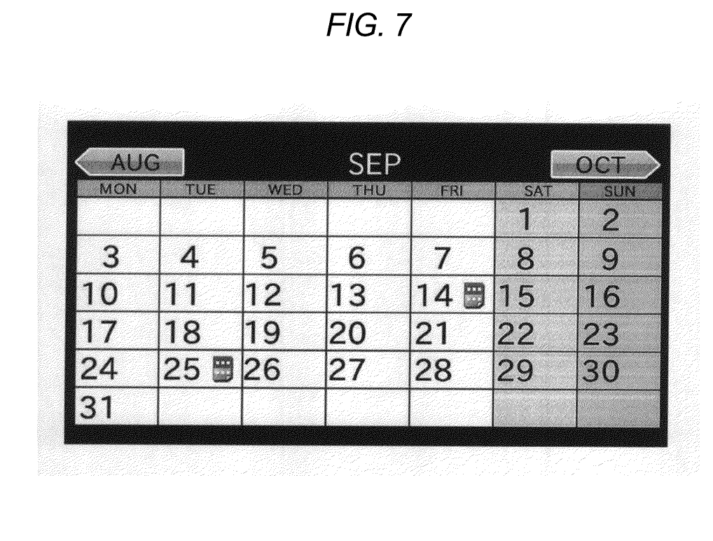

For example, an example of a shift of the user interface created when the associated image of printing execution is stored in the storage area 300b, will be specifically described as follows. FIG. 7 illustrates an example of a user interface in a calendar view format with the file icons displayed next to dates when the files were created. The user interface illustrated in FIG. 7 is defined so that the icon should be clicked to execute the printing.

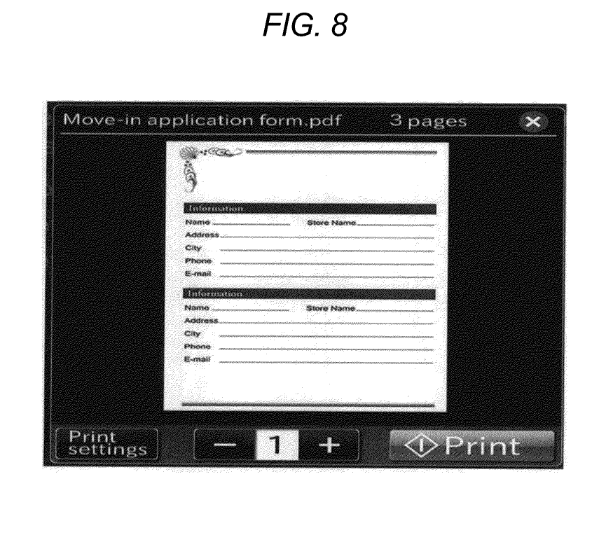

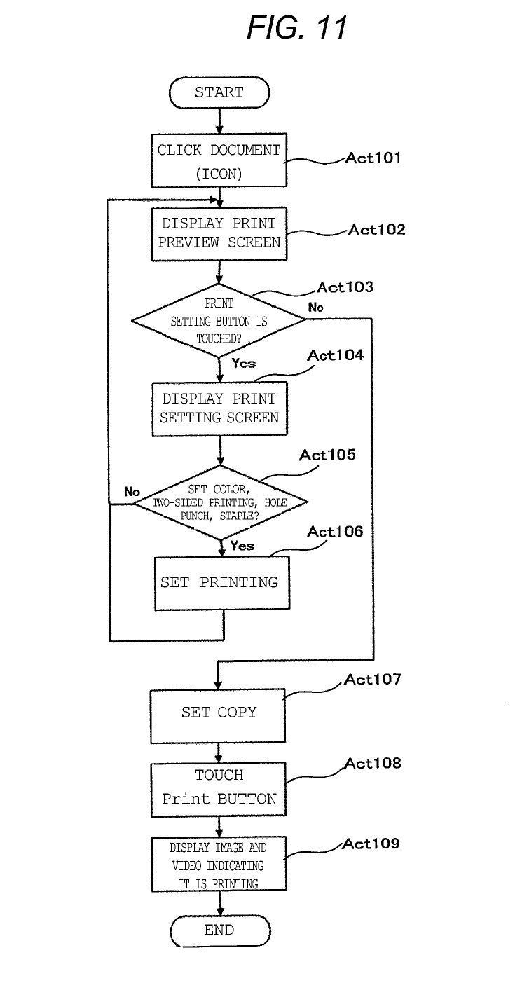

FIGS. 8 to 10 are examples of panels to be displayed according to the execution of the printing. FIG. 11 is a view showing a flow diagram according to the execution of the printing operation.

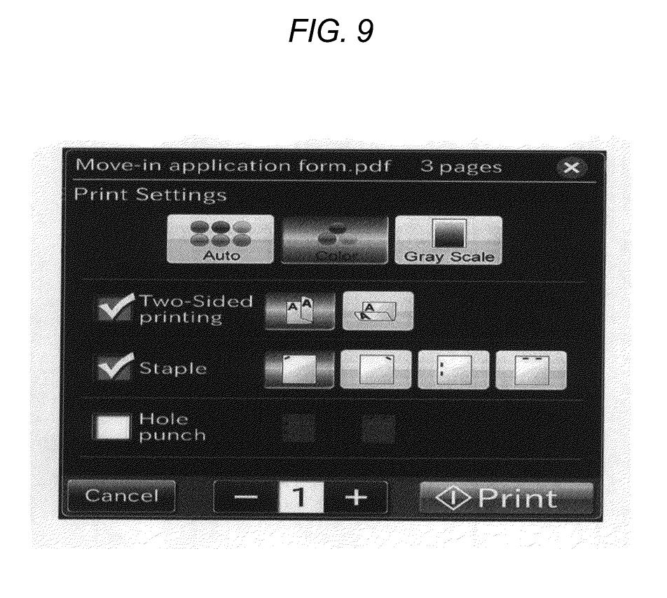

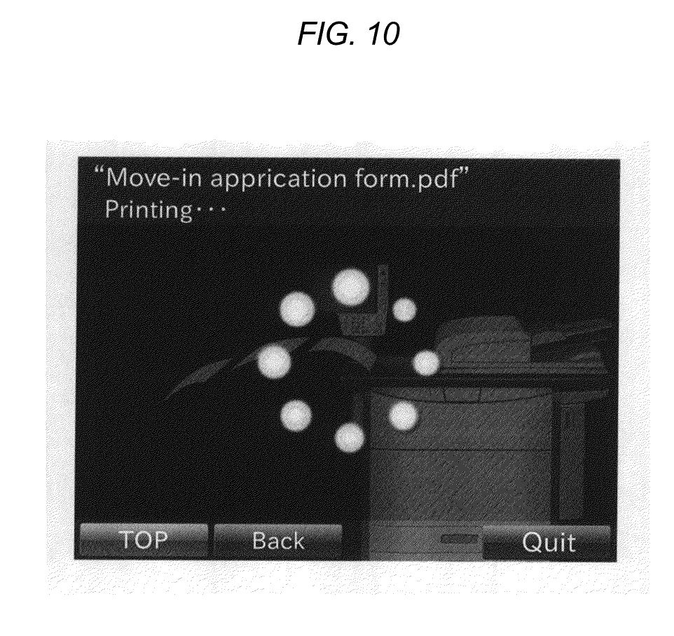

When the icon of a document file is clicked in the user interface shown in FIG. 7, the server 300 controls the MFP 200 to display a print preview panel on the display unit 200c as shown in FIG. 8. Here, the contents of the text to be printed can be confirmed and the number of the copy can be set. When “Print settings” button is clicked in the print preview panel in FIG. 8, a print setting panel as shown in FIG. 9 is displayed. Here, the panel is configured to be able to set the color, two-sided printing, staple, and hole punch; by using the print setting function, a user can print his or her specified article in a more desirable way. When “Print” button is touched on the panel of FIG. 9, the MFP 200 starts printing the selected document. According to the touchdown of the “Print” button, the display unit 200c shows the panel indicating that it is printing (FIG. 10).

As mentioned above, a shift of the panels corresponding to a specific function is designed in module and this is associated with the component related to the specific function in the user interface; therefore, a screen producer can create a user interface customized more easily.

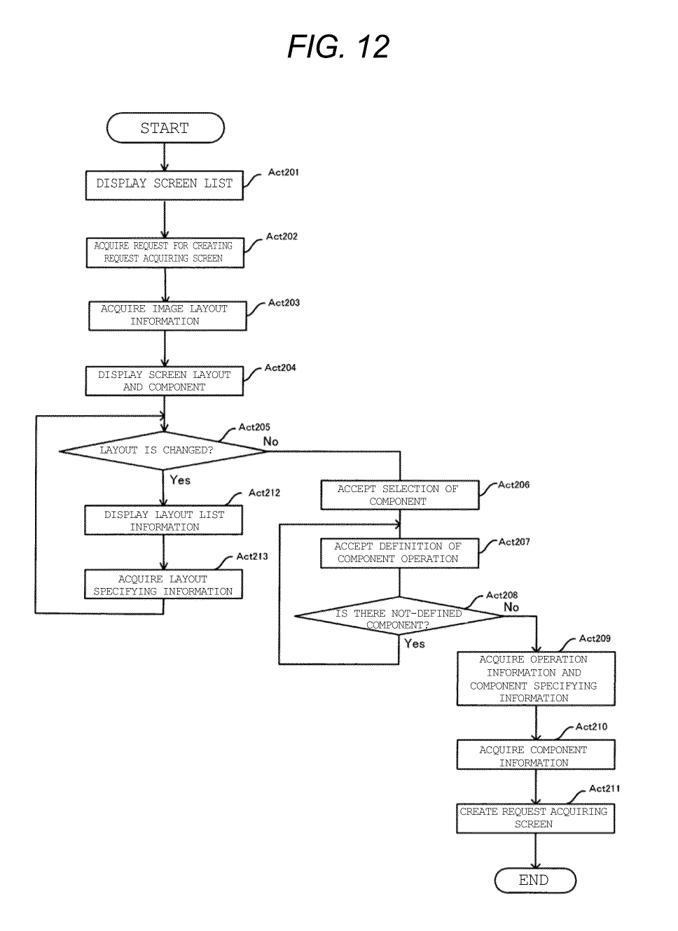

Next, a flow diagram of creating a user interface in the server 300 according to the embodiment will be described using FIG. 12.

In Act 201, in reply to a request from a screen producer, the server 300 displays a panel list stored in the storage area 300b. Based on the input using the list, the edit request acquiring unit 301 acquires a request for creating a user interface and the information for identifying the selected panel from a screen producer (Act 202).

In Act 203, the layout information acquiring unit 303 acquires the layout information stored in the storage area 300b, in response to the notice from the edit request acquiring unit 301. The layout information acquiring unit 303 transfers the acquired layout information to the presentation unit 305 and the panel edit unit 309. In Act 204, the presentation unit 305 creates a setting screen, for example, as illustrated in FIGS. 5 and 6, using the layout information, the component list information stored in the storage area 300b, and the setting screen information and displays the setting screen together with the screen indicating the layout on the display unit 300c.

If the screen layout is not changed on the setting screen (No in Act 205), a component selection is entered through the list box 811. The server temporarily stores the entered selection in the storage area (receiving the component specifying information in Act 206). Continuously, a function corresponding to the component is defined through the boxes 815 and 816. The server 300 temporarily stores the information about the function associated with the component into the storage area (receiving the operation information in Act 207). The server 300 checks whether there is such a component that is not defined (Act 208). If there remains a component that is not defined (Yes in Act 208), Act 207 and Act 208 are repeated. On the other hand, if there is no component as such (No in Act 208), the button 715 is touched and the edit operation acquiring unit 307 acquires the component specifying information and the function (Act 209). In Act 210, the component information acquiring unit 302 acquires the component information by using the component specifying information acquired from the edit operation acquiring unit 307. In Act 211, the panel edit unit 309 creates a user interface, by using the layout information acquired from the layout information acquiring unit, the function information acquired from the edit operation acquiring unit 307 (part operation acquiring unit), and the component information acquired from the component information acquiring unit 302.

On the other hand, when a request for presenting a layout list is entered through the list box 711 on the setting screen, the edit operation acquiring unit 307 acquires the above request and the presentation unit 305 displays the layout list information in the list box 711 (Act 212). In Act 213, the edit operation acquiring unit 307 acquires the layout identifying information entered through the list box 711 based on the presentation of the layout list information by the presentation unit 305.

As mentioned above, although one embodiment of the server has been described, it is not restricted to this embodiment. Other forms are possible.

By way of example, although the form of performing the operation for creating a user interface through the operation unit 300d of the server 300 and displaying the setting screen on the display unit 300c has been described, it is not restricted to this form. For example, a client PC may be used to perform the above operation, hence to create a user interface in the server through the network.

Although the embodiment has been described using a button in which a shift to another screen is defined, another type of components may be used. Further, a box or a window for specifying a component and defining a function as for the specified component may be changed in the contents depending on the type of the component.

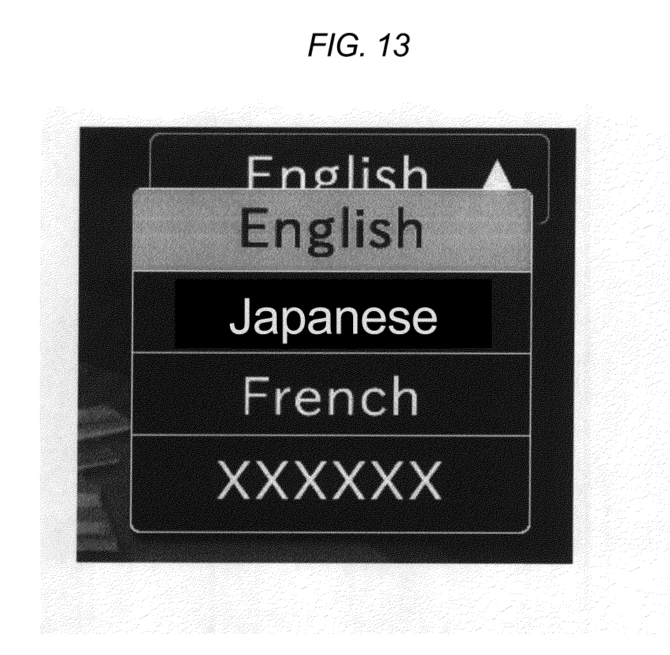

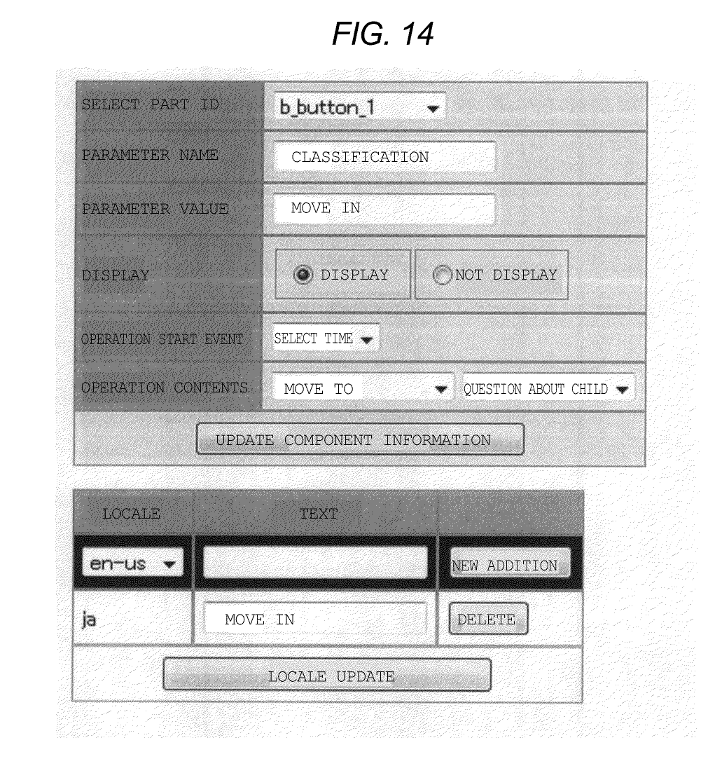

By way of example, a language switching button, which is set in the header, is provided as illustrated in FIG. 13. By arranging the language switching button, the letters to be displayed on the user interface are changeable to previously specified languages such as Japanese, English, French, and the like. The languages to be used are set within the system as resource files, associated with the component information of the language switching button; when a user operates the language switching button to display the language switching list, the corresponding file is read and displayed. Or a locale selection unit may be arranged on the setting screen, as illustrated in FIG. 14, as a function of the button, in the arrangement of the component button; the above unit can set which word to be set in which language, hence to switch the languages smoothly.

Further, although the print on-demand system has been described by way of example of the system including the server 300, it is not restricted to such a system. The system may be configured to display a user interface on a display unit included in an equipment working as a terminal for a user to enter an operation request, according to a control of the server. Byway of example, there is a product management system, in addition to the print on-demand system and as a terminal for a user to enter an operation request, there is, for example, RFID reader.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above. Furthermore, based on an indication of the program installed from the memory device to the computer, OS (operation system) operating on the computer, or MW (middle ware software), such as database management software or network, may execute one part of each processing to realize the embodiments.

As mentioned above, according to the server of the embodiment, components and the functions as for each component are set on a panel where the arrangement of the components is previously defined; therefore, a user interface customized for every system provider can be created more easily than ever.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server configured to create a user interface including one or more components, to be displayed on an operation display of a device, the server comprising:
a first unit configured to acquire layout information indicating a layout of the user interface in which one or more components are arranged;
a second unit configured to control a setting display to display information indicating the layout and a setting panel on which each of the components can be selected from a list of one or more components available for the layout and a function to be associated with each of the selected component can be selected;
a third unit configured to recognize the component and the function that are selected on the setting panel;
a fourth unit configured to acquire component information associated with the recognized component; and
a fifth unit configured to create the user interface based on the acquired layout information, the recognized function, and the acquired component information.

2. The server according to claim 1, further comprising:
a sixth unit configured to control the setting display to display a setting panel on which the layout of the user interface can be selected from a list of one or more available layouts.

3. The server according to claim 2, wherein
the first unit is configured to acquire default layout information if the first unit cannot acquire the layout information corresponding to the layout selected on the setting panel.

4. The server according to claim 1, wherein
the fifth unit is configured to acquire an image to be displayed on the operation display, if a component to be displayed on the operation display is associated with the image and the component associated with the image is selected on the setting panel.

5. The server according to claim 1, further comprising:
a storage configured to store the layout information to be acquired by the first unit, the component and the function to be presented in the setting panel, and the component information to be acquired by the fourth unit.

6. The server according to claim 5, wherein
the storage is configured to store the user interface that is created by the fifth unit.

7. The server according to claim 1, wherein
the device is an image forming apparatus.

8. A method for creating a user interface including one or more components to be displayed on an operation display of a device, the method comprising:
acquiring layout information indicating a layout of the user interface in which one or more components are arranged;
controlling a setting display to display information indicating the layout and a setting panel on which each of the components can be selected from a list of one or more components available for the layout and a function to be associated with each of the selected components can be selected;
recognizing the component and the function that are selected on the setting panel;
acquiring component information associated with the recognized component; and
creating the user interface based on the acquired layout information, the recognized function, and the acquired component information.

9. The method according to claim 8, further comprising:
controlling the setting display to display a setting panel on which the layout of the user interface can be selected from a list of one or more available layouts.

10. The method according to claim 9, wherein
the layout information that is to be acquired is default layout information if the layout information corresponding to the layout selected on the setting panel cannot be acquired.

11. The method according to claim 8, further comprising
acquiring an image to be displayed on the operation display, if a component to be displayed on the operation display is associated with the image and the component associated with the image is selected on the setting panel.

12. The method according to claim 8, further comprising:
storing the layout information to be acquired, the component and the function to be presented in the setting panel, and the component information to be acquired.

13. The method according to claim 8, further comprising:
storing the user interface that is created.

14. The method according to claim 8, wherein
the device is an image forming apparatus.

15. A non-transitory computer readable medium comprising a program that is executable in a computer system to cause the computer system to perform a method for creating a user interface including one or more components to be displayed on an operation display of a device, the method including the steps of:
acquiring layout information indicating a layout of the user interface in which one or more components are arranged;
controlling a setting display to display information indicating the layout and a setting panel on which each of the components can be selected from a list of one or more components available for the layout and a function to be associated with each of the selected components can be selected;
recognizing the component and the function that are selected on the setting panel;
acquiring component information associated with the recognized component; and
creating the user interface based on the acquired layout information, the recognized function, and the acquired component information.

16. The non-transitory computer readable medium of claim 15, the method further comprising:
controlling the setting display to display a setting panel on which the layout of the user interface can be selected from a list of one or more available layouts.

17. The non-transitory computer readable medium of claim 16, wherein
the layout information that is to be acquired is default layout information if the layout information corresponding to the layout selected on the setting panel cannot be acquired.

18. The non-transitory computer readable medium of claim 15, the method further comprising:
acquiring an image to be displayed on the operation display, if a component to be displayed on the operation display is associated with the image and the component associated with the image is selected on the setting panel.

19. The non-transitory computer readable medium of claim 15, the method further comprising:
storing the layout information to be acquired, the component and the function to be presented in the setting panel, and the component information to be acquired.

20. The non-transitory computer readable medium of claim 15, wherein
the device is an image forming apparatus.
